(19) United States
(12) Patent Application Publication
(10) Pub. No.: US 2003/0014529 A1
(43) Pub. Date: Jan. 16, 2003

(54) Mediated access to production device options in a distributed environment

(76) Inventors: Shell Sterling Simpson, Boise, ID (US); Garth Frederick Schmeling, Boise, ID (US); Kenneth Lee Oakeson, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/905,580

(22) Filed: Jul. 12, 2001

(51) Int. Cl. G06F 15/16

(52) U.S. Cl. 709/229; 709/225

(57) ABSTRACT

Mediating access to production options. A method embodying the invention includes acquiring a user's request for a production device and providing the user with an interface for the production device, the interface having user accessible controls for only those options for which the user has permission to access. In one embodiment the interface is generated upon request based upon an electronic record containing data identifying which options the user has permission to access. In another embodiment, an existing interface is modified upon request based upon an electronic record containing data identifying which options the user has permission to access. Once generated or modified the interface is presented to the user.

### FIELD OF THE INVENTION

The present invention is directed to a method and system for electronic document production. More particularly, the invention is directed to a method and system for mediating access to production device options in a distributed environment.

### BACKGROUND OF THE INVENTION

In a basic desktop computing environment, a printer or other production device is connected directly to a computer. Production devices include printers; finishers such as a binder, sorter, or folder; e-mail clients; facsimile devices; web server; and electronic data storage devices. However, production devices are not limited to those listed but may include any device capable of electronically or physically saving, displaying, formatting, or transferring a target document. To produce a document, a user either opens or creates an electronic document using a word processor or other application. The user then issues a production request for a selected production device. A driver, specific to the selected production device—a printer in this example—generates a user interface allowing the user to select options for formatting the document. Among others, these options can include the number of copies, print resolution, specific paper source and output bins. With the desired production options selected, the driver formats the production request into a specialized series of commands directing the printer to produce the document on one or more sheets of paper. To add a new production device, the user simply connects the new device and installs the new driver for that device on the computer.

In a more complex environment, the computer and production devices are components of a larger network of electronic devices. A number of network users can share a common production device such as a printer. Using device management software application, a system administrator is able to manage and limit access to that printer. While new printers and other production devices can be easily connected to the network, drivers for those devices must be individually installed on each client computer that accesses the new device. As updates for the device drivers become available, the updates must also be installed on each client computer.

With the ever-expanding resources provided by the Internet, document production has taken a dramatic step forward. Becoming more autonomous, production devices are being designed to connect directly to and communicate over the Internet. Rather than being controlled by a device driver installed on a desk-top computer or separate print server, these new production devices contain their own programming.

In one new system, a client computer, utilizing a web browser rather than a particular device driver, accesses a web server embedded in a production device such as a printer. Representing that device on the network, the embedded web server allows the device to be connected directly to the network rather to another device such as a desktop computer. When accessed by a browser, the embedded web server returns a web page containing controls for formatting and printing a selected document. With the document and desired format options selected, the browser returns the document and the user's formatting instructions to the embedded web server, which, in turn, self-manages production of the document on the device.

In another new system, the client computer, using a browser, accesses a print service—a web site hosted on a server computer. The print service presents the user with a selection of printers from which to choose. The browser returns the user's printer selection along with the location of the components of the document to be printed. For example, the text of the document may be located in one location on the network while the color graphics for a cover page may be located elsewhere. The print service then directs the web browser to a web server embedded in the selected printer. That web server returns a web page allowing the user to select formatting options for the document. With the options selected, the print service compiles the document's components and delivers them along with the selected formatting options to the web server embedded in the selected production device.

Generally, these new systems are designed to eliminate the need for centralized device management. However, as it is with conventional document production, it is desirable, if not essential, in some cases to provide some centralized control over a group of production devices. For example, a professional printing business may provide access to a group of production devices over the Internet. That business, however, may desire to limit access to those devices to a group of specified customers. More particularly that business may wish to limit access to particular options provided by those devices. While a device may have the ability to print in color, the business may desire to allow a particular user or group of users to print only in black and white. Consequently, what is needed is a method and system for mediating access to production options in these new systems for network document production.

### SUMMARY OF THE INVENTION

Accordingly, the present invention involves mediating access to production options. A method embodying the invention includes acquiring a user's access request for a production device and providing the user with an interface for the production device, the interface having user accessible controls for only those options for which the user has permission to access. In one embodiment the interface is generated upon request based upon an electronic record containing data identifying which options the user has permission to access. In another embodiment, an existing interface is modified upon request based upon an electronic record containing data identifying which options the user has permission to access. Once generated or modified the interface is presented to the user.

### DESCRIPTION OF THE DRAWINGS

FIG. 1 is a schematic representation of a computer network that includes several client devices, a server device, and several production devices.

FIG. 2 is a block diagram of the network of FIG. 1 in which the invented permission service is embodied in a program running on the server device according to one embodiment of the present invention.

FIG. 3 is a block diagram further illustrating the logical components of the permission service according to one embodiment of the present invention.

FIG. 4 is a visual representation of a user record according to one embodiment of the present invention.

FIG. 5 is a visual representation of a device record according to one embodiment of the present invention.

FIG. 6 is an exemplary screen view of a permission interface generated by the permission service.

FIG. 7 is a flow diagram illustrating the document production process provided by the permission service according to one embodiment of the present invention.

FIG. 8 is a flow diagram illustrating the document production process provided by the permission service according to a second embodiment of the present invention.

FIGS. 9A and 9B are exemplary screen views of an interface for selecting production options.

### DETAILED DESCRIPTION OF THE INVENTION

Glossary:

Program: An organized list of electronic instructions that, when executed, causes a device to behave in a predetermined manner. A program can take many forms. For example, it may be software stored on a computer's disk drive. It may be firmware written onto read-only memory. It may be embodied in hardware as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, programmable gate arrays (PGA), field programmable gate arrays (FPGA), or other components.

Client-Server: A model of interaction between two programs. For example, a program operating on one network device sends a request to a program operating on another network device and waits for a response. The requesting program is referred to as the “client” while the device on which the client operates is referred to as the “client device.” The responding program is referred to as the “server,” while the device on which the server operates is referred to as the “server device.” The server is responsible for delivering requested information back to the client. In any given network there may be multiple clients and multiple servers. A single device may contain programming allowing it to operate both as a client device and as a server device. Moreover, a client and a server may both operate on the same device.

Interface: The junction between a user and a computer program providing commands or menus through which a user communicates with a program. The term user in this context represents generally any individual or mechanism desiring to communicate with the program. For example, in the client-server model defined above, the server usually generates and delivers to a client an interface for communicating with a program operating on or controlled by the server device. Where the server is a web server, the interface is a web page. The web page when displayed by the client device presents a user with controls for selecting options, issuing commands, and entering text. The controls displayed can take many forms. They may include push-buttons, radio buttons, text boxes, scroll bars, or pull-down menus accessible using a keyboard and/or a pointing device such as a mouse connected to a client device. In a non-graphical environment, the controls may include command lines allowing the user to enter textual commands.

Introduction: In a new model for network document production, a user identifies and provides a self-representing production device access to a target document. A target document is an electronic document selected for production. A target document may comprise two or more components. For example, the document's text may be stored in one electronic file while the document's graphics are stored in another. Each component may be stored on a different network device. The term store should be taken liberally. A network device that “stores” a component may not actually store anything, but will be capable of servicing requests related to the “stored” item. To identify the target document, a user need only locate the target document's components and provide instructions on accessing those components.

A self-representing production device has the ability, without the aid of a second device, to communicate over a network and produce a target document upon request. For example, a production device such as a conventional printer is incapable of self-representation and must be connected to and controlled by a second device such as a desktop computer or a print server. A self-representing device typically contains a production server facilitating network communication and managing document production.

To utilize a self-representing device, a user sends a request to access (an “access request”) a production server operating on the device selected to produce the target document. The production server returns a user interface allowing the user to select production options for the target document. A production device, such as a conventional printer, usually provides only one service, printing. Other production devices provide multiple services. A single device may be able to provide printing, copying, scanning, and facsimile services. For each service, there may exist a number of production options. For example, when printing a document, options can include duplexing, landscape or portrait orientation, and finishes such as stapling or sorting. The instructions for accessing the target document along with selected production options are returned to the production server, which, in turn, retrieves the target document and manages its production in accordance with the selected options.

It is expected that by providing a permission service, embodiments of the invention will allow centralized management of the production devices within this new model.

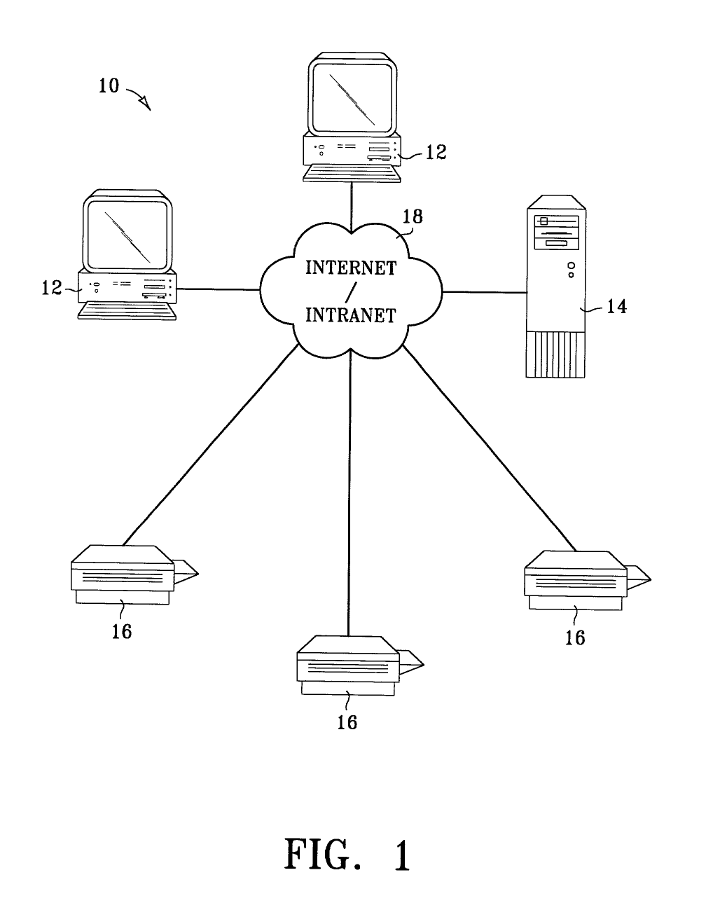

Although the various embodiments of the invention disclosed herein will be described with reference to the computer network 10 shown schematically in FIG. 1, the invention is not limited to use with network 10. The invention may be implemented in or used with any computer system in which it is necessary or desirable to produce electronic documents. The following description and the drawings illustrate only a few exemplary embodiments of the invention. Other embodiments, forms, and details may be made without departing from the spirit and scope of the invention, which is expressed in the claims that follow this description.

Referring to FIG. 1, network 10 represents generally any local or wide area network in which a variety of different electronic devices are linked. Network 10 includes client devices 12, typically personal computer workstations. However, client device 12 represents generally any device, a personal digital assistant for example, capable of displaying a user interface. Network 10 also includes server device 14 and production devices 16. While shown as printers, production devices 16 represent any production device present on network 10. While capable of other functions, server device 14 need only facilitate communication between client devices 12 and production devices 16.

Communication link 18 interconnects client devices 12, server 14, and production devices 16. Communication link 18 represents generally a cable, wireless, or remote connection via a telecommunication link, an infrared link, a radio frequency link, or any other connector or system that provides electronic communication between devices 12, 14, and 16. Communication link 18 may represent an intranet, an Internet, or a combination of both. The path followed by link 18 between devices 12, 14, and 16 in the schematic view of FIG. 1 represents the logical communication path between these devices, not necessarily the physical path between the devices. Devices 12, 14, and 16 can be connected to the network at any point and the appropriate communication path established logically between the devices.

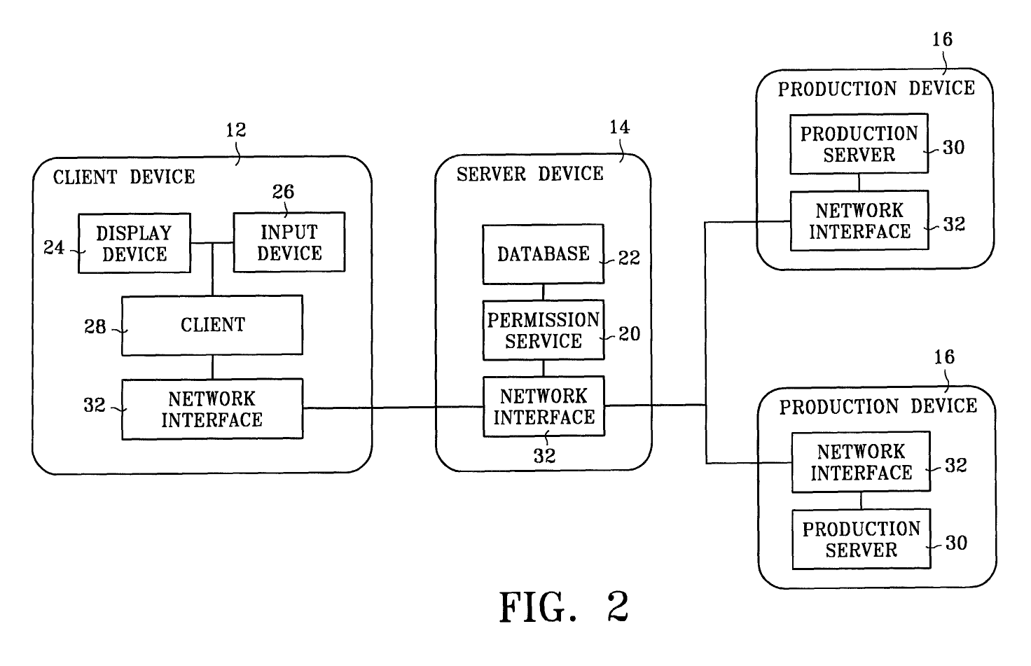

Components: The logical components of one embodiment of the invented document production system will now be described with reference to the block diagrams of FIGS. 2-4. In FIG. 2, the invention is embodied in software or other programming labeled permission service 20 operating on server device 14. Permission service 20, described in more detail below, represents generally programming capable of mediating network communication between client device 12 and production devices 16. Database 22 represents generally any memory for storing data used by permission service 20. Client device 12 provides a mechanism for presenting a user with an interface for managing document production on production devices 16. Client device 12 usually includes a monitor or other suitable display device 24 and a keyboard and/or a pointing device such as a mouse or other suitable input device 26. Client 28 is a program for causing display device 22 to display a desired interface and for delivering instructions to permission service 20. Consequently, while client device 12 is illustrated as a device separate from server device 14 and production devices 16, the function of client device 12, specifically client 28, can be incorporated into any network device capable of providing a user interface, which may include devices 14 and/or 16. While FIG. 2 illustrates permission service 20 operating on server device 14, it may just as well operate on one or more production devices 16 or on one or more client devices 12. Production devices 16 are self-representing, each containing a production server 30. Production servers 30 represent generally any programming capable of providing an interface for selecting production options and then managing production of a document using production options selected through that interface. To facilitate network communication between devices 12, 14, and 16, each includes network interface 32.

It is envisioned that production servers 30 will be web servers and that client 28 will be a web browser. A web server is a program that hosts documents, commonly referred to as Web pages, for remote retrieval over a network such as the World Wide Web. Usually, a web server functions as software operating on a network computer, but can be firmware embedded into production devices 16. Web pages can be delivered in a number of formats including, but not limited to, HTML (Hyper-Text Markup Language) and XML (eXtensible Markup Language). The web pages may be generated on demand using server side scripting technologies including, but not limited to, ASP (Active Server Pages) and JSP (Java Server Pages). A web browser is a client program for requesting and displaying web pages.

Using HTML (hyper-text mark up language) and/or another internet language, production servers 30 each create an interface in the form of a web page having an assigned network address. The network address is usually in the form of an URL (Uniform Resource Locator) or IP (Internet Protocol) address. Beneficially, this allows cross platform communication. For example, production servers 30 may be functioning under one operating system such as Linux® while client device 12 may be running Microsoft® Windows®.

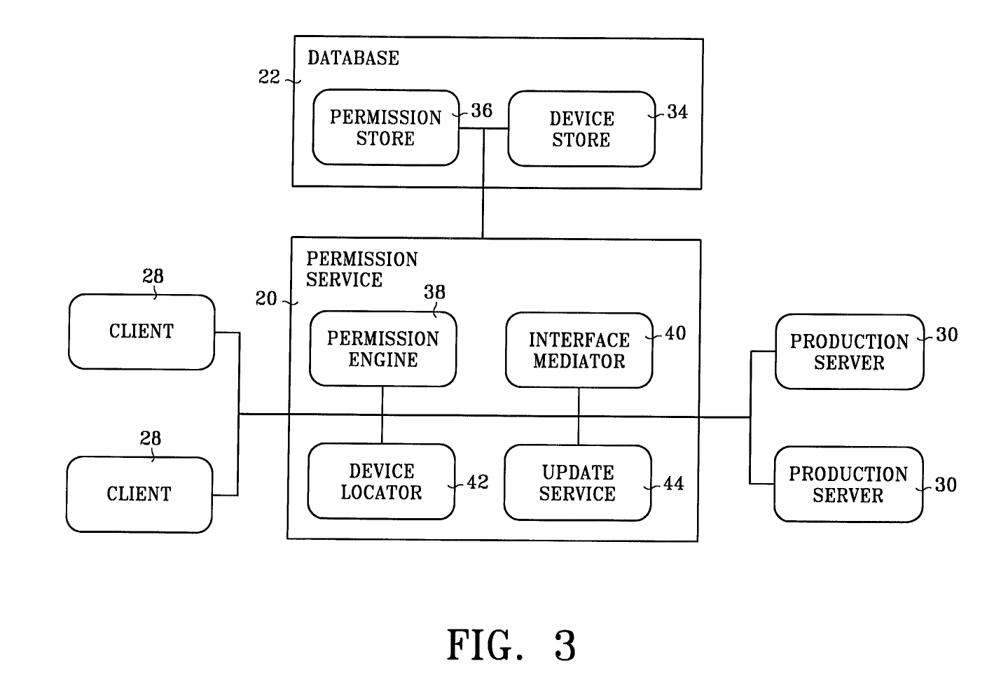

The components of permission service 20 and database 22 will be described generally with reference to FIG. 3. A more detailed description of their functions and the expected interaction between the components will follow. Database 22 includes device store 34 and permission store 36. Device store 34 represents generally data relating to available production devices and their options. Permission store 36 represents generally data relating to authorized users and each user's access to the options of available production devices. Permission service 20 includes permission engine 38, interface mediator 40, device locator 42, and update service 44. Permission engine 38 represents generally any programming capable of managing permission store 36. Interface mediator 40 represents generally any programming capable of acquiring a user's access request for a specified production device 16 and providing the user with a production interface for the specified production device 16 according to the user's data contained in permission store 36. Device locator 42 embodies generally any programming capable of detecting and identifying new devices connected to network 10, while update service 44 embodies generally any programming capable of updating device store 34 with data relating to the newly detected devices and their options.

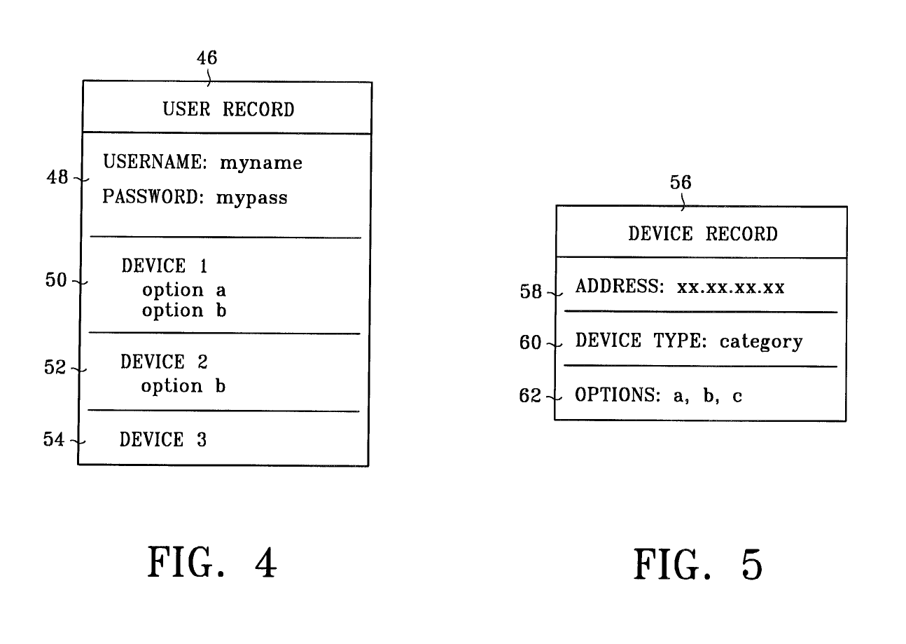

Permission store 36 contains a record 46 for each authorized user, a representation of which is illustrated in FIG. 4. Each record 46 includes a number of fields. In the example of FIG. 4, record 46 includes credentials field 48 and device fields 50, 52, and 54. Credentials field 48 provides a means to identify a particular user using, in this example, a user name and password. Device fields 50, 52, and 54 provide a means to identify device options available to the particular user. In field 50 for device 1, options “a” and “b” are listed. Depending upon how the record is read, this could mean that the particular user either has access to or is denied access to those options. The same can be said for fields 52 and 54.

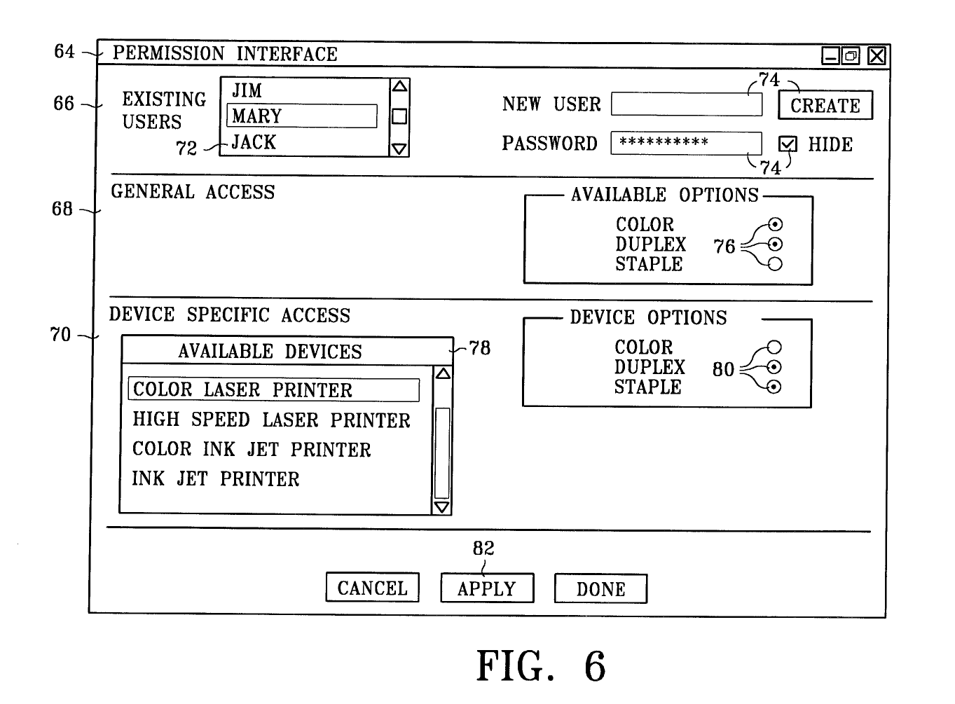

Device store 34 contains a record 56, represented in FIG. 5, for one or more devices 16 on network 10. Each record 56 includes an address field 58, a type field 60, and an options field 62. Address field 58 provides a means for locating the particular device on network 10. In the example of FIG. 5, the address is in the form of an IP address. Type field 60 provides a means for categorizing the particular device. It may he useful to access device records based upon a particular category. These categories may include printers, scanners, copiers, or any other generic identifier for a production device. Options field 62 lists the options available on the particular device. A record for a laser printer, for example, may list options such as color printing and duplexing.

As described above, it is envisioned that permission service 20 and production servers 30 will each function, at least in part, as web servers and that client 28 will be a web browser. The production interface for each device 16 will be a web page having user accessible controls for selecting production options for that device. When issuing an access request for a particular production device 16, client 28 will provide the user's credentials. These credentials can include a username and password or any other system for identifying the user. Other authentication schemes are envisioned and are within the scope of this application, including, but not limited to, public key authentication schemes that use certificates rather than passwords.

Before presenting client 28 with the web page for a particular device 16, interface mediator 40, using the supplied credentials, access the user's record 46 in permission store 36 and identifies which, if any, of the device's production options the user has permission to utilize. In one embodiment, interface mediator 40 then provides production server 30 for the particular device 16 with the user's permissions. Production server 30 then generates a web page providing access to controls for only those production options the user has permission to access.

In an alternative embodiment, interface mediator 40 retrieves an existing web page from production server 30 for the particular device 16, modifies that web page according to the user's permissions such that the web page, when displayed, provides access to controls for only those production options the user has permission to access. Each web page contains programming for displaying controls for selecting production options. Generally, there are distinct sets of code for displaying the control or controls for each production option. Each of those sets may include a tag identifying the particular production option. After obtaining the web page for a particular device 16, interface mediator 40 parses the web page's programming and locates the tags identifying those production options not accessible by the particular user. Interface mediator 40 then alters the web page removing the code associated with those tags. As a result, when the web browser displays the web page, the user is only presented with controls for selecting those production options available to the user. Alternatively, interface mediator 40 could alter the code associated with those tags such that when the web page is displayed, the user can see but not access controls for selecting those production options not available to the user.

As illustrated in FIG. 3, permission service 20 includes device locator 42 and update service 44. Using SNMP (Simple Network Management Protocol) for example, device locator 42 detects when a new device 16 is connected to network 10 and identifies the new device determining whether device store 34 contains a record for the newly connected device 16. If not, update service 40 obtains the production interface for the device 16. Parsing the programming for the interface, update service generates a record 56 for the device 16 and stores that record in device store 34. For example, when device locator 42 detects the addition of a new device it identifies the device as a color laser printer of a particular model from a particular manufacturer. Not finding a record for the printer in device store 34, update service 40 establishes communication with the production server 30 operating on the newly connected printer requesting the interface for the device. Assuming the interface is a web page, update service 40 parses the web page identifying the options provided by the printer. Update service then creates and stores a record fore the printer in device store 34.

The block diagrams of FIGS. 1-3 show the architecture, functionality, and operation of one implementation of permission service 20. If embodied in software, each block may represent a module, segment, or portion of code that comprises one or more executable instructions to implement the specified logical function(s). If embodied in hardware, each block may represent a circuit or a number of interconnected circuits to implement the specified logical function(s).

Also, permission service 20 can be embodied in any computer-readable medium for use by or in connection with an instruction execution system such as a computer/processor based system or other system that can fetch or obtain the logic from the computer-readable medium and execute the instructions contained therein. A “computer-readable medium” can be any medium that can contain, store, or maintain permission service 20 for use by or in connection with the instruction execution system. The computer readable medium can comprise any one of many physical media such as, for example, electronic, magnetic, optical, electromagnetic, infrared, or semiconductor media. More specific examples of a suitable computer-readable medium would include, but are not limited to, a portable magnetic computer diskette such as floppy diskettes or hard drives, a random access memory (RAM), a read-only memory (ROM), an erasable programmable read-only memory, or a portable compact disc.

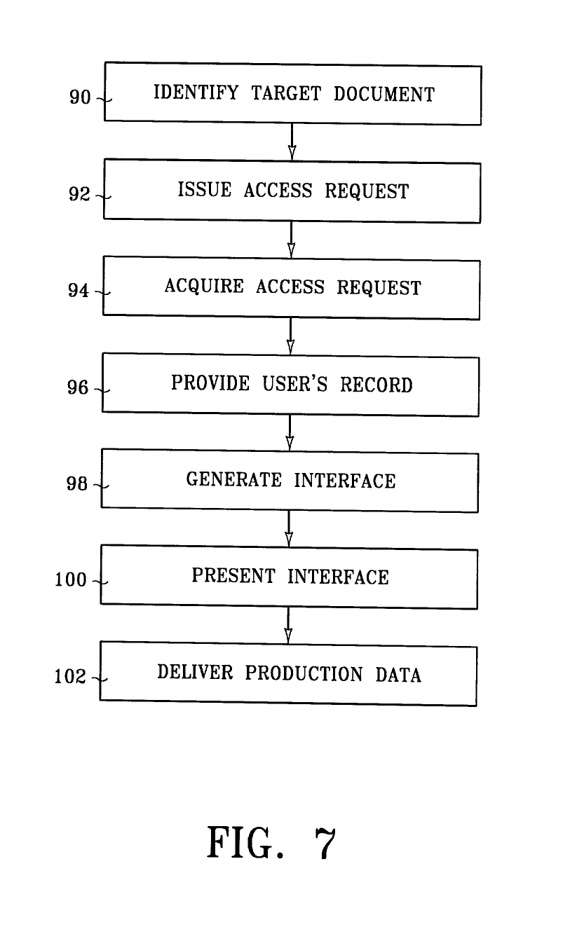

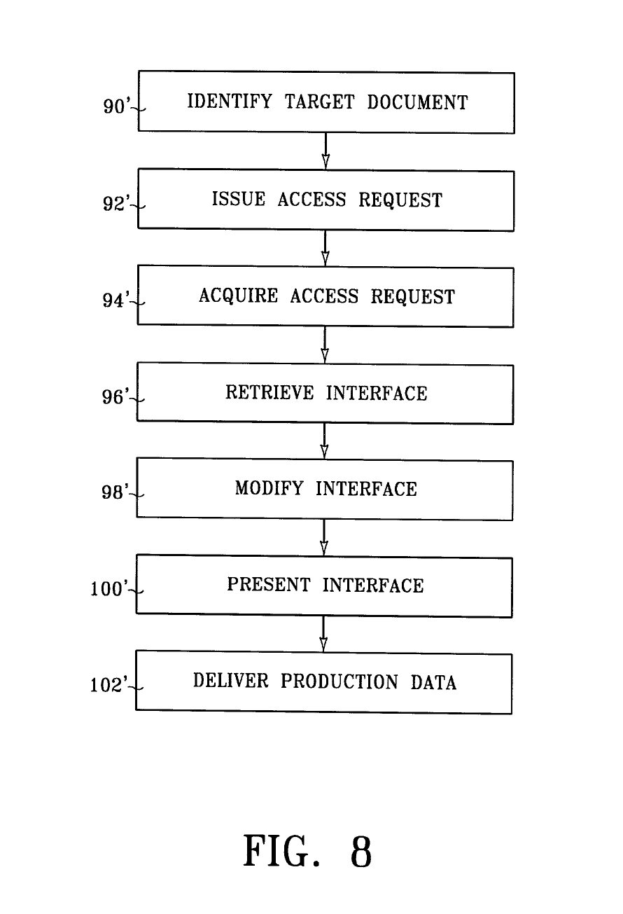

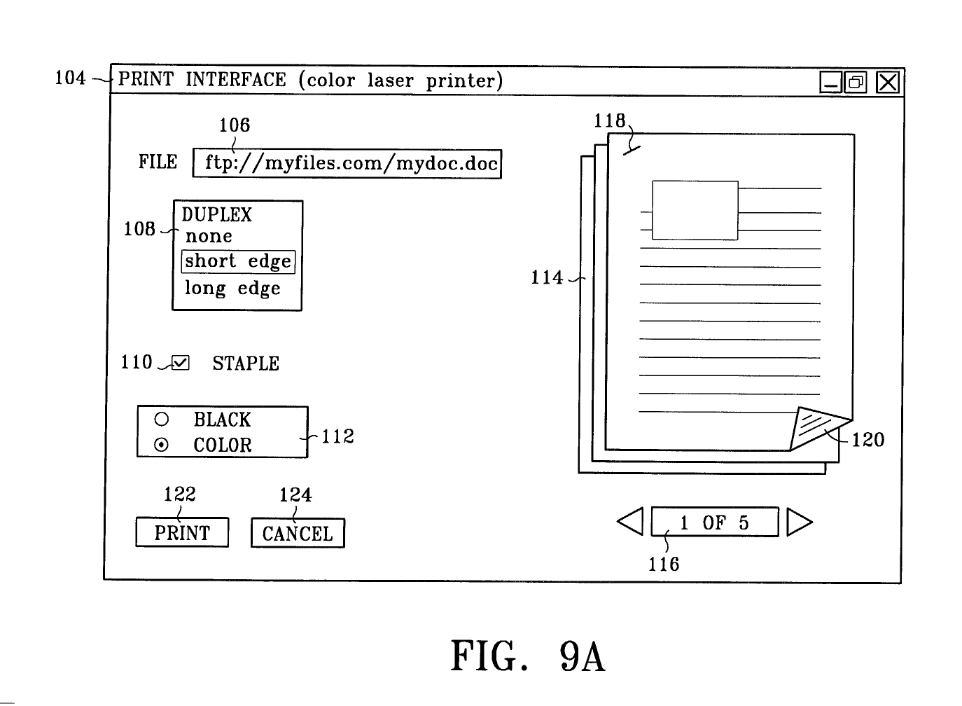

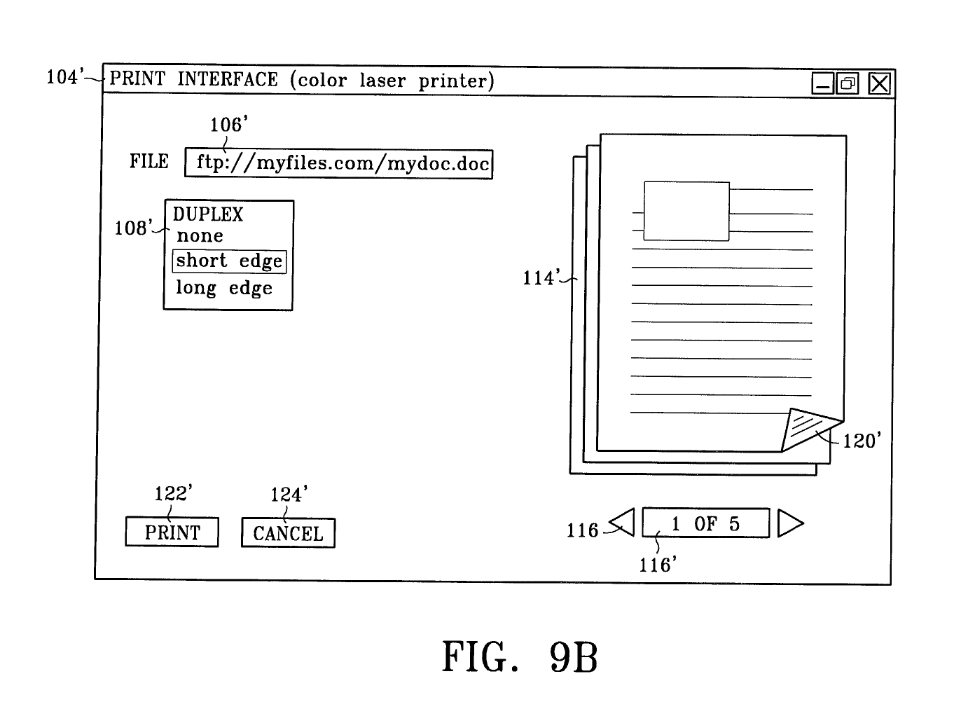

Operation: The operation of permission service 20 will now be described with reference to the flow diagrams of FIGS. 7 and 8 and the exemplary screen views of FIGS. 6, 9A and 9B. FIG. 6 illustrates a sample interface for creating or editing user records. FIG. 7 provides an example of the steps taken to produce a document using permission service 20 according to a first embodiment. FIG. 8 provides an example of the steps taken to produce a document using permission service 20 according to a second embodiment. FIG. 9A illustrates a sample interface for a printer providing access to all production options. FIG. 9B illustrates a sample interface for the same printer in which access to some production options is restricted.

From time to time, a system administrator or other user may desire to access and modify user records 46 of permission store 36. Using client 28, the administrator accesses permission service 20 providing the appropriate credentials. Referring now to FIG. 6, permission engine 38 verifies those credentials and returns permission interface 64. Permission interface includes user accessible controls for selecting production options available to each user. In this example, interface 64 is separated into user identification section 66, general access section 68, and device specific access section 70. Identification section 66 includes control 72 for selecting an existing user's record and controls 74 for adding a record for a new user. General access section 68 includes controls 76 for selecting production options available to a specified user for all production devices. For a specified production device, specific access section 70 includes controls 78 and 80 for overriding selections made in general access section 68. In this example, control 68 is a scroll menu allowing the administrator to select a particular device. Controls 80 allow the administrator to select production options available to a specified user for that particular device.

When generating interface 64, permission engine 38 contacts permission store 36 and obtains a list of existing users, providing that list in user section 66. Permission engine 38 also contacts device store 34 and obtains a list of all production options available, providing that list in general access section 68. Finally, permission engine 38 obtains from device store 34 a list of available devices and generates control 78. For each device represented in control 78, permission engine 38 obtains a list of production options available for the particular device and generates controls 80.

In the example of FIG. 6, the administrator has selected the existing user MARY using control 72. Permission engine 38 identified only three different production options available on network 10—color printing, duplexing, and stapling. These options are represented in controls 76. For each device, the administrator has selected to allow the user MARY to print in color, duplex, but not staple. The administrator has also selected to override those general permission settings for COLOR LASER PRINTER selected in control 78. For that device, the administrator has chosen to allow the user MARY access to all production options except color printing. Once all the desired selections are made, the administrator can select control 82 to apply those selections updating the user's record in permission store 36.

The steps taken to produce a document using permission service 20 will now be described with reference to FIG. 7. Using client 28, a target document is identified (step 90). Client 28 issues an access request for a selected production device 16 (step 92). Interface mediator 40 acquires the access request (step 94) and provides production server 30 for the particular device 16 with the user's record 46 from permission store 36 (step 96). Production server 30 generates a production interface for device 16 according to the user's record 46 (step 98). The interface, when displayed will provide the user access to controls for only those options the user has permission to access. Production server 30 then presents the interface to client 28 (step 100). Production data identifying the target document and representing the production options selected through the interface are then delivered to production device 16 (step 102).

FIG. 8 illustrates alternative steps taken to produce a document using permission service 20. Using client 28, a target document is identified (step 90′). Client 28 issues an access request for a selected production device 16 (step 92′). Interface mediator 40 acquires the access request (step 94′). Interface modifier 40 retrieves an existing interface for production device 16 from production server 30 (step 96′). Using credentials for the particular user, interface mediator 40 then modifies, if necessary, the interface according to the user's record in permission store 36 (step 98′). Interface mediator 40 then presents the modified interface to client 28 (step 100′). Production data identifying the target document and representing the production options selected through the interface is then delivered to production device 16 (step 102′).

As discussed above, it is envisioned that client 28 will be a web browser. When issuing an access request in step 92, client 28 browses to the network address assigned to the selected production device 16. This address may take the form of an URL (Uniform Resource Locator) or an IP (internet Protocol) address. Acquiring in step 94 may be accomplished in a number of ways. Interface mediator 40 might monitor and intercept network communication directed to production device 16. It is envisioned, however, that when client 28 browses to the network address for the selected production device 16, production server 30 for the selected device 16 will return a web page redirecting client 28 to permission service 20. The modified interface presented to client 28 in step 100 includes instructions identifying the selected production device 16 as the ultimate recipient of production data selected through the modified interface. For example, the web page for a particular production device is associated with the URL—“http://printer.company.com.” Permission service 20 is accessed through the URL—http://permission.company.com. When issuing an access request, client 28 browses to http://printer.company.com. The production server 28 for the selected device 16 returns a web page redirecting client 28 to the URL—http://permission.company.com/ref?device=http://printer.company.com. In this manner, permission service 20 is able to later access the URL for the selected production device 16 which is indicated following the “ref?device=” portion of the above URL.

In a second example, a directory service is used. The term directory service embodies generally any programming capable of providing a listing of available production devices and instructions for accessing those devices. The directory service may be located on server device 14 but need only be accessible by client 28. To issue an access request, client 28 browses to the directory service, which returns an interface for selecting a production device. When production device 16—access to which is controlled by permission service 20—is selected, the directory service redirects client 28 to permission service 20 providing permission service 20 with the identity of the selected production device 16. For example, the interface produced by the directory service may include a link to each production device. For production device 16 controlled by permission service 20, that link is a link to permission service 20 with a reference to the address of production device 16. Using the exemplary URLs from above, the link would be “<a href=“http://permission.company.com/ref?device=http://printer.company.com”>.”

It may be desirable or necessary in some cases to present client 28 with more than one interface in step 100 before all production data can be delivered in step 102. For example, the number of production options available for a selected production device 16 may require more controls than can be displayed on one screen. The device 16 may provide advanced production options that users generally do not access. In these situations, step 100 involves presenting client 28 with an initial interface. The initial interface includes controls or other means for requesting each subsequent interface. For example, once a user has selected the desired production options on the initial interface, the user may select a control to access a subsequent interface for selecting advanced production options. It is envisioned, then, that the initial and each subsequent interface provided to client 28 will include instructions identifying the selected production device 16 as the ultimate recipient of the production data.

In step 102, the production data may be sent from client 28 directly to production device 16, or the production data may be forwarded through permission service 20.

FIG. 9A illustrates a screen displaying production interface 102 for a printer as presented in steps 100 and 100′ of FIGS. 7 and 8. In this example, the particular user has permission to access each of the available production options. Interface 104 includes control 106 for identifying the target document. Controls 108 through 112 allow the user to select options such as duplexing, stapling, and color printing. Control 114 provides a print preview for the document allowing the user to visualize the document before printing. Where the document contains multiple pages, control 116 to scroll through and review each page. Print preview control 114 also reflects selected production options. Icon 118 shows that staple control 110 has been selected. Icon 120 shows that duplex control 108 has been selected. With the desired options selected, the user can then select print control 122 or may select cancel control 124.

FIG. 9B illustrates a screen displaying production interface 104′ for a printer as presented in steps 100 and 100′ of FIGS. 7 and 8. In this example, however, the particular user does not have permission to access the staple or color options represented by controls 110 and 112 in FIG. 9A. In this example, interface mediator 40 has modified the programming for interface 104′ to cause controls for selecting these options not to be displayed. Alternatively interface mediator 40 might gray or otherwise alter the controls allowing the user to see but not select the options when the interface is displayed.

Although the flow chart of FIGS. 7 and 8 show a specific order of execution, the order of execution may differ from that which is depicted. For example, the order of execution of two or more blocks may be scrambled relative to the order shown. Also, two or more blocks shown in succession in FIG. 5 may be executed concurrently or with partial concurrence. All such variations are within the scope of the present invention. The screen displays of FIGS. 6, 9A, and 9B are exemplary only. There exist many possible layout and control configurations for interfaces that will allow a user to edit or create user records and to select available production options. FIGS. 6, 9A, and 9B merely provide examples.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A method for mediating access to production options, comprising:
acquiring a user's access request for a production device; and
providing the user with an interface for the production device, the interface having user accessible controls for only those options for which the user has permission to access.

2. The method of claim 1, wherein the act of acquiring comprises intercepting an access request directed to the production device.

3. The method of claim 1, wherein the act of acquiring comprises redirecting the access request.

4. The method of claim 1, wherein the act of providing comprises:
accessing data representing production options to which the user does and/or does not have permission to access;
generating an interface according to the accessed data providing user accessible controls for only those options for which the user has permission to access; and
presenting the user with the generated interface.

5. The method of claim 4, wherein the act of accessing comprises obtaining credentials for the user and locating a user record using the credentials, the user record containing the data representing production options to which the user does and/or does not have permission to access.

6. The method of claim 4 wherein the act of generating comprises generating the interface in the form of a web page and the act of presenting comprises presenting the generated web page to a web browser.

7. The method of claim 1, wherein the act of providing comprises:
retrieving an interface for the production device, the interface having user accessible controls for selecting production options for the production device;
modifying the interface to allow the user access to the controls for only the production options for which the user has permission to access; and
presenting the user with the modified interface.

8. The method of claim 7, wherein the act of modifying comprises:
accessing data representing production options to which the user does and/or does not have permission to access; and
modifying the interface according to the accessed data providing user accessible controls for only those options for which the user has permission to access.

9. The method of claim 8, wherein the interface is a web page containing instructions for displaying controls for selecting production options and wherein the instructions are associated with one or more tags each tag identifying a particular production option, wherein the act of altering comprises identifying the tags for production options to which the user does not have access and altering the instructions associated with those tags.

10. The method of claim 8, wherein the act of accessing comprises obtaining credentials for the user and locating a record for the user using the credentials, the record containing the data representing production options to which the user does and/or does not have permission to access.

11. The method of claim 7, wherein the acts of retrieving and modifying are performed on a network device other than the production device.

12. The method of claim 7 wherein the act of retrieving comprises retrieving the interface in the form of a web page, and the act of presenting comprises presenting the modified web page to a web browser.

13. A method for mediating access to production options, comprising:
acquiring a user's access request for a production device;
accessing a record established for the user, the record containing data representing the production options for the production device to which the user does and/or does not have permission to access;
generating a web page for the production device according to the user's record; and
presenting the user with the generated interface.

14. A method for mediating access to production options, comprising:
acquiring a user's access request for a production device;
retrieving a web page for the production device, the web page having user accessible controls for selecting production options;
accessing a record established for the user, the record containing data representing the production options for the production device to which the user does and/or does not have permission to access; and
altering the web page according to the user's record; and
presenting the user with the modified web page.

15. A computer program product for mediating access to production options, the product comprising a computer useable medium having computer readable instructions thereon for:
acquiring a user's access request for a production device; and
providing the user with an interface for the production device, the interface having user accessible controls for only those options for which the user has permission to access.

16. The product of claim 10, wherein the instructions for acquiring include instructions for intercepting an access request directed to the production device.

17. The product of claim 10, wherein instructions for acquiring include instructions for redirecting the access request.

18. The product of claim 15, wherein the instructions for providing comprise instructions for:
accessing data representing production options to which the user does and/or does not have permission to access;
generating an interface according to the accessed data, the interface having user accessible controls for only those options for which the user has permission to access; and
presenting the user with the generated interface.

19. The product of claim 18, wherein the instructions for accessing comprise instructions for obtaining credentials for the user and locating a user record using the credentials, the user record containing the data representing production options to which the user does and/or does not have permission to access.

20. The product of claim 18, wherein the instructions for generating comprise instructions for generating the interface in the form of a web page and the instructions for presenting comprise instructions for presenting the generated web page to a web browser.

21. The product of claim 15, wherein the instructions for providing comprise instructions for:
retrieving an interface for the production device, the interface having user accessible controls for selecting production options for the production device;
modifying the interface to allow the user access to the controls for selecting only production options for which the user has permission to access; and
presenting the user with the modified interface.

22. The product of claim 21, wherein the instructions for modifying comprise instructions for:
accessing data representing the production options for the production device to which the user does and/or does not have permission to access; and
altering the interface according to the accessed data, the altered interface having user accessible controls for only those production options for which the user has permission to access.

23. The product of claim 22, wherein the interface is a web page containing instructions for displaying the controls for selecting each of the production options and wherein the instructions are associated with one or more tags each tag identifying a particular production option, wherein the instructions for altering include instructions for identifying the tags for production options to which the user does not have access and altering the instructions associated with those tags.

24. The product of claim 22, wherein the instructions for accessing include instructions for obtaining credentials for the user and locating a user record using the credentials, the user record containing the data representing the production options for the production device to which the user does and/or does not have permission to access.

25. The product of claim 21, wherein the instructions for retrieving and modifying comprise instructions for retrieving and modifying from a device other than the production device.

26. The product of claim 21, wherein the instructions for retrieving comprises instructions for retrieving the interface in the form of a web page and the instructions for presenting comprises instructions for presenting the web page to a web browser.

27. A computer program product for mediating access to production devices, the product comprising a computer useable medium having computer readable instructions thereon for:
acquiring a user's access request for a production device;
accessing data representing production options to which the user does and/or does not have permission to access;
generating an interface according to the accessed data, the interface having user accessible controls for only those options for which the user has permission to access; and
presenting the user with the generated interface.

28. A computer program product for mediating access to production devices, the product comprising a computer useable medium having computer readable instructions thereon for:
acquiring a user's access request for a production device;
retrieving a web page for the production device; the interface having user accessible controls for selecting production options for the production device;
accessing a record established for the user, the record containing data representing the production options for the production device to which the user does and/or does not have permission to access;
altering the web page according to the accessed data, the altered interface having user accessible controls for only those production options for which the user has permission to access; and
presenting the user with the modified web page.

29. In a computer network, a system for managing electronic document production, the system comprising:
a production device;
a client operable to identify a target document, issue a user's access request for a selected production device, and select production options;
a permission service in electronic communication with the client and the production device, the permission service operable to acquire the access request for the production device and provide the user with an interface for the production device, the interface having user accessible controls for only those options for which the user has permission to access.

30. The system of claim 29, wherein an interface is a web page and the client is a web browser.

31. The system of claim 29, further comprising one or more user records accessible by the permission service, each user record containing data representing the production options to which the user does and/or does not have permission to access for the production device.

32. The system of claim 31, further comprising:
a production server operable to generate an interface according to a user's record;
wherein the permission service is operable to direct the production server to generate an interface according to the user's record and to direct to the client the generated interface.

33. The system of claim 31, further comprising:
a production server operable to serve an interface according to a user's record, the interface having user accessible controls for selecting production options for the target document;
wherein the permission service is operable to retrieve an interface from the production server for a selected production device, modify the interface according to the user's record, and direct to the client the modified interface.

34. The system of claim 31, further comprising a permission engine operable to generate an interface having user accessible controls for managing user records.

35. The system of claim 34, further comprising one or more device records, each device record containing data representing the production options offered by the particular production device, and wherein the permission engine is operable to parse the device records to generate the interface for managing the user records.

36. The system of claim 35, further comprising:
a device locator operable to detect new production devices; and
an update service operable to create a device record for each newly detected production device.

37. In a computer network, a system for managing electronic document production, the system comprising:
a production device;
one or more user records, each user record containing data representing the production options to which the particular user does and/or does not have permission to access;
a production server in communication with the production device and operable to generate an interface for that production device according to a user record;
a client operable to identify a target document, issue a user's access request for the production device, and select production options;
a permission service operable to access the user's record, direct the production server to generate an interface for the production device according to the user's record, and to direct to the client the generated interface;
one or more device records, each device record containing data representing the production options offered by the particular production device;
a permission engine operable to parse the device records and generate an web page for managing user records;
a device locator operable to detect new production devices; and
an update service operable to create a device record for each newly detected production device.

38. In a computer network, a system for managing electronic document production, the system comprising:
a production device;
one or more user records, each user record containing, for each production device, data representing the production options to which the particular user does and/or does not have permission to access;
a production server in communication with the production device and operable to serve an interface for that production device, the interface having user accessible controls for selecting production options for the production device;
a client operable to identify a target document, issue a user's access request for the production device, and select production options;
a permission service operable to access the user's record, retrieve the interface from the production server, modify the interface according to the user's record, and to direct to the client the modified interface;
one or more device records, each device record containing data representing the production options offered by the particular production device;
a permission engine operable to parse the device records and generate an web page for managing user records;
a device locator operable to detect new production devices; and
an update service operable to create a device record for each newly detected production device.
